(19) United States
(12) Patent Application Publication
(10) Pub. No.: US 2009/0201419 A1
(43) Pub. Date: Aug. 13, 2009

(54) SIGNAL PROCESSING APPARATUS

(75) Inventor: Tatsuya TAKEI, Hachioji-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/350,499

(22) Filed: Jan. 8, 2009

(30) Foreign Application Priority Data
Feb. 8, 2008 (JP) 2008-029680

(51) Int. Cl. H04N 5/04

(52) U.S. Cl. 348/500; 348/E05.009

(57) ABSTRACT

A signal processing apparatus includes an analog signal outputting circuit configured to output an analog signal divided into blocks in synchronization with a clock. An operation circuit is configured to operate in a clamping state to hold a reference signal and in a signal outputting state to output an effective signal by performing a specific operation on the analog signal with respect to the reference signal. A control circuit is configured to control the operation circuit and causes the operation circuit to operate in the clamping state longer than a period in which one block of the analog signal is output while the operation circuit remains in the signal outputting state.

### CROSS-REFERENCE TO RELATED APPLICATIONS

This application is based upon and claims the benefit of priority from prior Japanese Patent Application No. 2008-029680, filed Feb. 8, 2008, the entire contents of which are incorporated herein by reference.

### BACKGROUND OF THE INVENTION

1. Field of the Invention

The present invention relates to a signal processing apparatus that can read, within a short time, the pixel signals generated by any CCD image sensor.

2. Description of the Related Art

The CCD image sensor used as an optical sensor element has a light receiving unit that is composed of a number of optoelectric transducer elements arranged in a column. The signal charges the light receiving unit generates are transferred to a CDD transfer path. Thereafter, each signal charge generated in one optoelectric transducer element is read as a pixel signal. The pixel signal is read in response to a transfer clock that is synchronous with the control clock supplied to the CCD image sensor. In an ordinary type of CCD image sensor, the electric charge is transferred before the pixel signals are read, purging unnecessary electric charge from the CCD transfer path, which may result in noise due to the unnecessary charge. Hence, some time is required to transfer the unnecessary charge.

Methods of shortening the time for transfer of the unnecessary charge in a CCD image sensor are disclosed in Jpn. Pat. Appln. KOKAI Publication No. 3-163407 and Japanese Patent No. 3881395.

FIG. 13 is a diagram explaining the concept of the method described in Jpn. Pat. Appln. KOKAI Publication No. 3-163407. In the control sequence of FIG. 13, a high-speed transfer clock is used to purge the unnecessary charge before the pixel signals are read. Further, a low-speed transfer clock is used when the pixel signals are read. As a result, the time for reading the pixel signals is shortened.

FIG. 14 is a diagram explaining the concept of the method described in Japanese Patent No. 3881395. In the control sequence of FIG. 14, a low-speed transfer clock is used to read necessary pixel signals in the form of voltage signals. Further, a high-speed clock is used when the pixel signals other than the necessary ones are read or when an unnecessary charge is purged. The time for reading the pixel signals is thereby shortened.

The clamp signals shown in FIGS. 13 and 14 are signals that set a clamping circuit in clamping state, enabling the circuit to hold the reference voltage. The clamping circuit is configured to output the voltage signal read from the CCD image sensor, while clamp signals are level “L”. The output voltage of the clamping circuit is operationally amplified with respect to the reference voltage.

### BRIEF SUMMARY OF THE INVENTION

According to an aspect of the invention, there is provided a signal processing apparatus comprising: an analog signal outputting circuit configured to output an analog signal divided into blocks in synchronization with a clock; an operation circuit configured to operate in a clamping state to hold a reference signal and in a signal outputting state to output an effective signal by performing a specific operation on the analog signal with respect to the reference signal; and a control circuit configured to control the operation circuit, causing the operation circuit to operate in the clamping state longer than a period in which one block of the analog signal is output while the operation circuit remains in the signal outputting state.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a CCD image sensor unit and a control circuit for controlling the sensor unit, which may be used in ranging sensors for use in cameras;

FIG. 2 is a timing chart showing the waveforms of various control signals supplied to the CCD image sensor unit and the waveform of a signal output from the CCD image sensor;

FIG. 3 is a magnified part of the timing chart of FIG. 2, which concerns the pixel reading state;

FIG. 4 is a diagram showing a reading circuit for reading the output of the CCD image sensor unit;

FIG. 5 is a circuit diagram of the clamping circuit incorporated in the reading circuit of FIG. 4;

FIG. 6 is a timing chart showing the waveforms of the various control signals supplied to the analog signal output circuit incorporated in the reading circuit of FIG. 4 and also the waveforms of the signals output from various circuits in the analog signal output circuit;

FIG. 7 is a timing chart showing the waveforms of the control signals supplied to the operation circuit incorporated in the reading circuit of FIG. 4 and also the waveforms of the signals output from the operation circuit;

FIG. 8 is a diagram schematically illustrating the pixel configuration of the light receiving unit of the CCD image sensor;

FIG. 9 is a timing chart outlining the sequence of signal clamping;

FIG. 10 is a diagram showing a first example of means for setting the clamping period t_{CLP} longer than the one-pixel reading period t_{SIG};

FIG. 11 is a diagram showing a second example of means for setting the clamping period t_{CLP} longer than the one-pixel reading period t_{SIG};

FIG. 12 is a diagram showing a third example of means for setting the clamping period t_{CLP} longer than the one-pixel reading period t_{SIG};

FIG. 13 is a first timing chart explaining how pixel signals are read in a conventional method; and

FIG. 14 is a second timing chart explaining how pixel signals are read in another conventional method.

### DETAILED DESCRIPTION OF THE INVENTION

Embodiments of the present invention will be described with reference to the accompanying drawings.

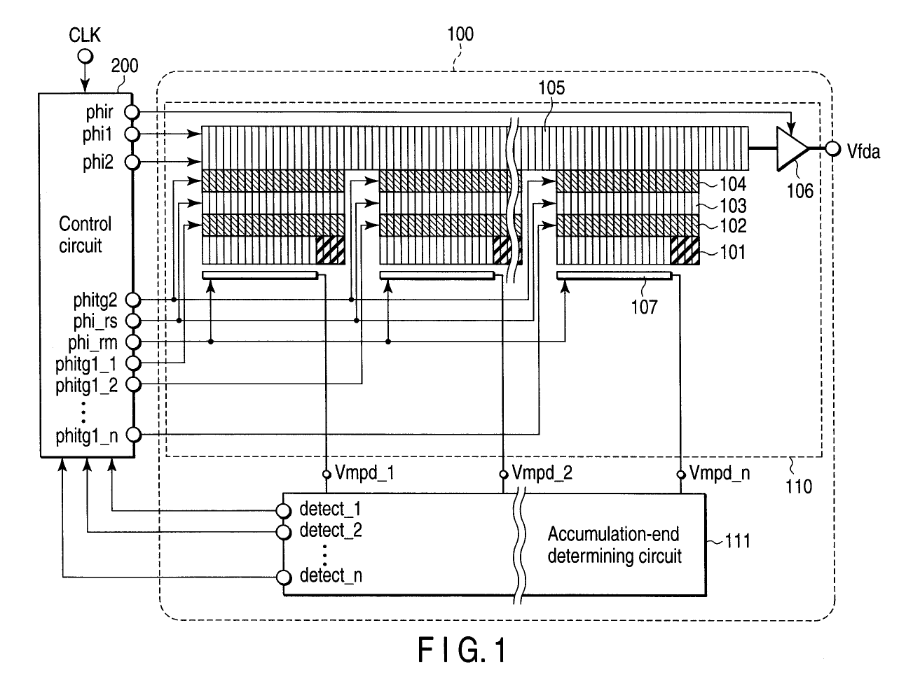

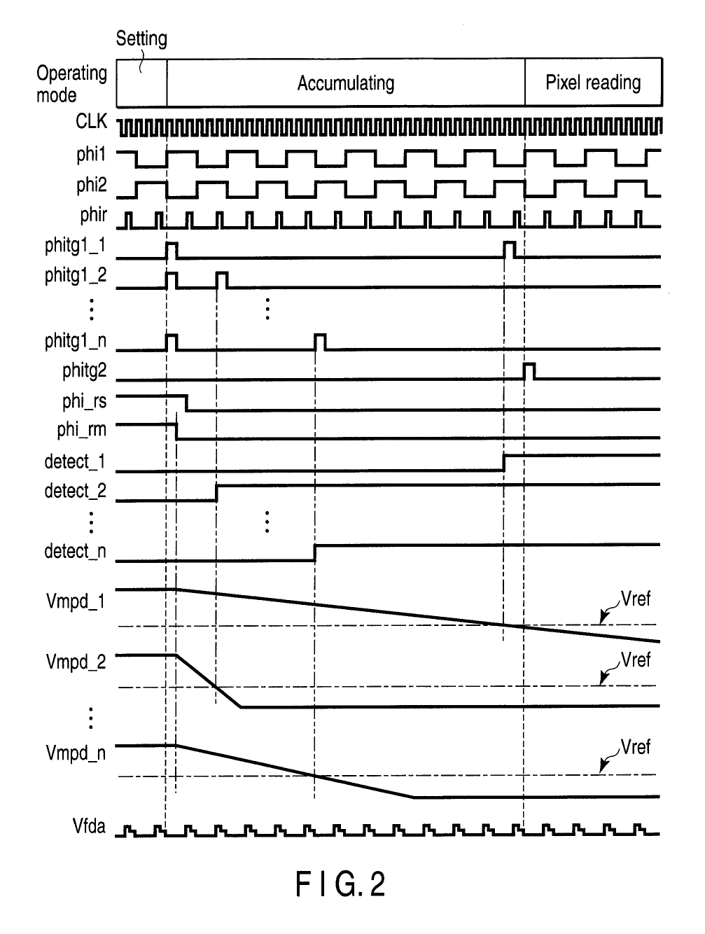

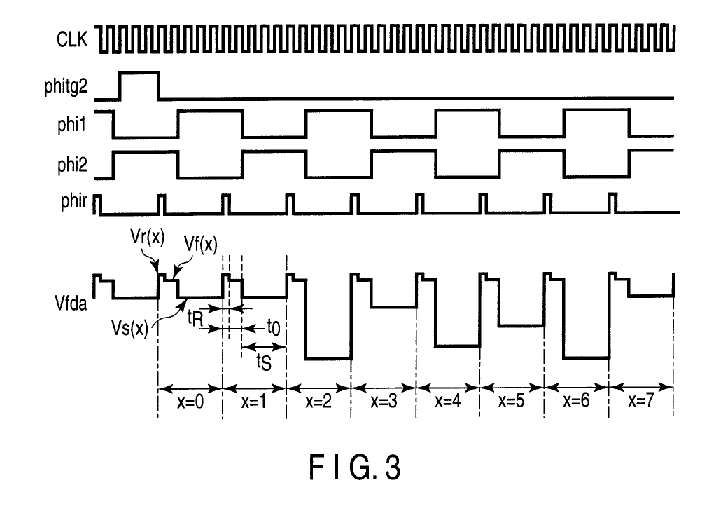

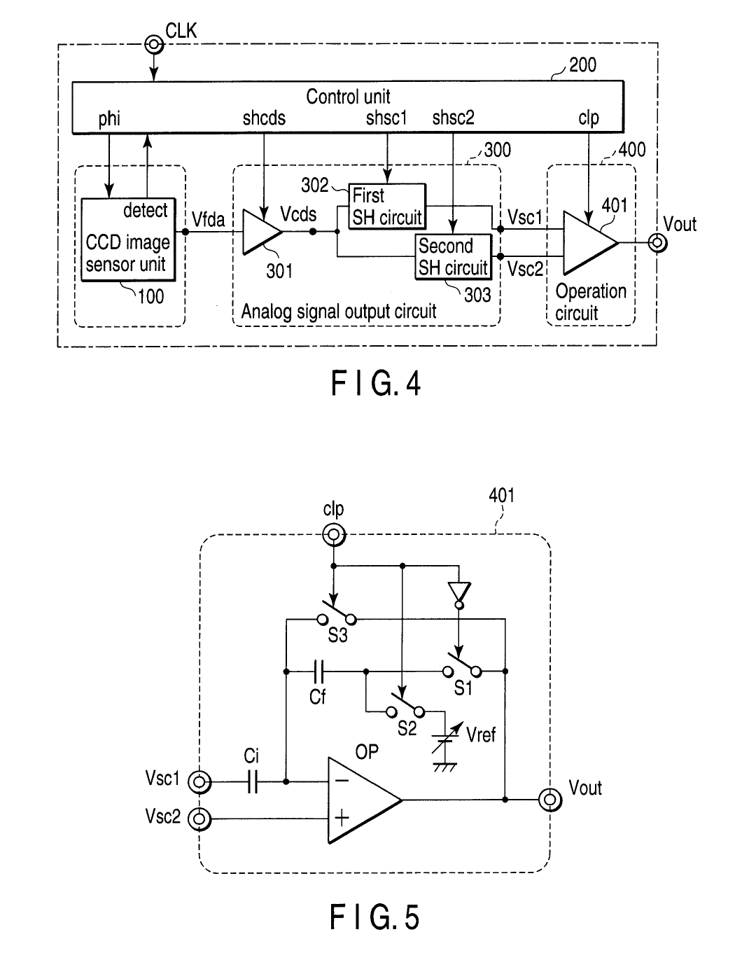

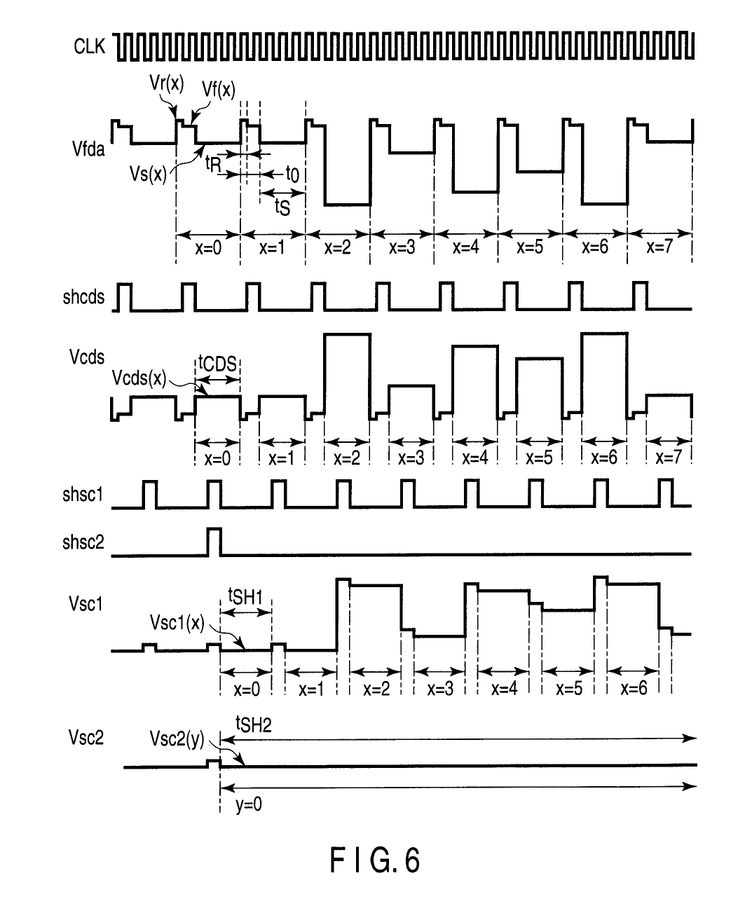

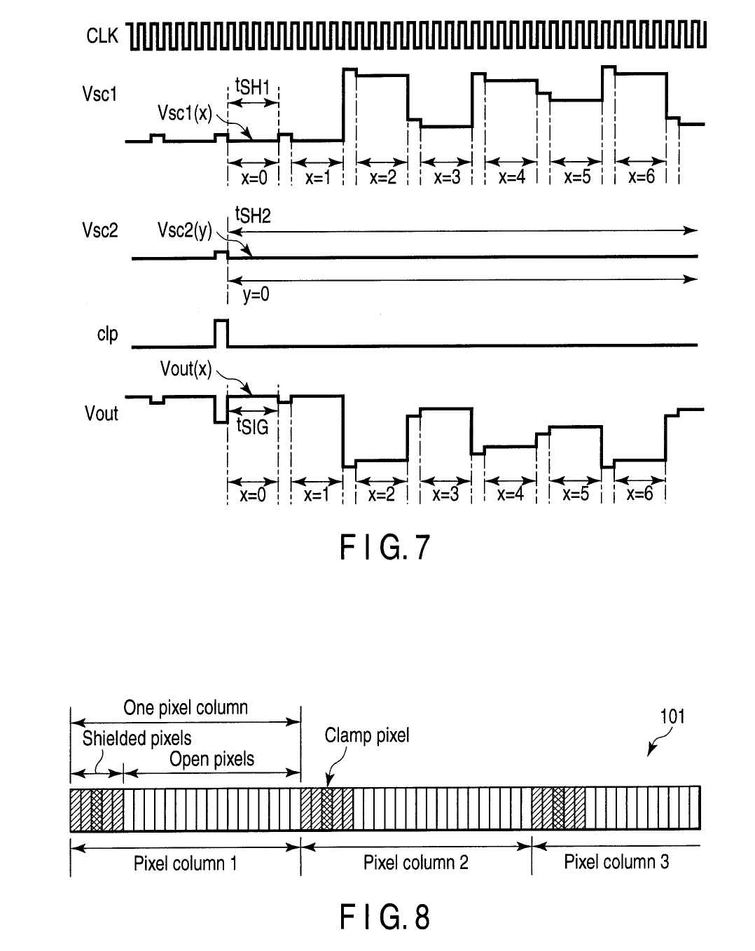

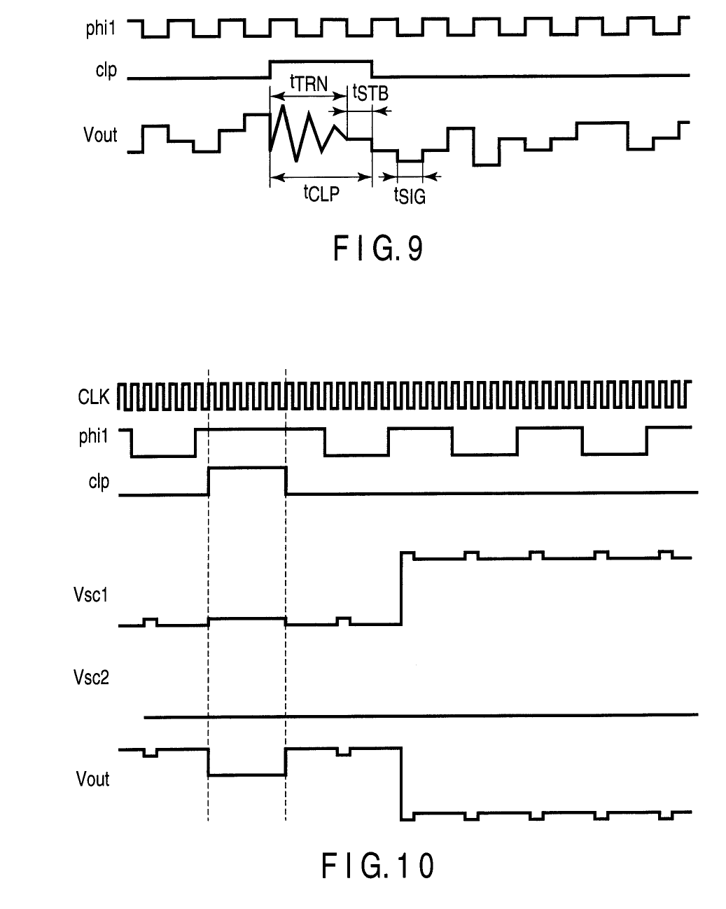

FIGS. 1 to 9 are diagrams showing a signal processing apparatus according to an embodiment of the invention. FIG. 1 is a diagram showing the CCD image sensor unit and a control circuit for controlling the sensor unit, both being of the types used in ranging sensors for cameras. FIG. 2 is a timing chart showing the waveforms of various control signals supplied to the CCD image sensor unit and the waveform of a signal output from the CCD image sensor. FIG. 3 is a magnified part of the timing chart of FIG. 2, which concerns the pixel reading state. FIG. 4 is a diagram showing a reading circuit for reading the output of the CCD image sensor unit. FIG. 5 is a circuit diagram of the clamping circuit that is incorporated in the reading circuit of FIG. 4. FIG. 6 is a timing chart showing the waveforms of the various control signals supplied to the analog signal output circuit incorporated in the reading circuit of FIG. 4 and also the waveforms of the signals output from various circuits in the analog signal output circuit. FIG. 7 is a timing chart showing the waveforms of the control signals supplied to the operation circuit incorporated in the reading circuit of FIG. 4 and also the waveforms of the signals output from the operation circuit. FIG. 8 is a diagram schematically illustrating the pixel configuration of the light receiving unit of the CCD image sensor. FIG. 9 is a timing chart outlining the sequence of signal clamping.

The circuit shown in FIG. 1 has a CCD image sensor unit 100 and a control circuit 200. The CCD image sensor unit 100 is configured to convert an optical signal to an electric signal. The electric signal is output to a reading circuit, as will be described later. The control circuit 200 controls the CCD image sensor unit 100. The control circuit 200 controls the reading circuit, too.

The CCD image sensor unit 100 will be described in detail.

The CCD image sensor unit 100 has a sensing unit 110 and an accumulation-end determining circuit 111. The sensing unit 110 has a light receiving unit 101, an accumulation gate unit 102, a storage unit 103, a transfer gate unit 104, a CCD transfer path 105, a floating diffusion amplifier (FDA) 106, and a monitor pixel unit 107.

The light receiving unit 101 comprises a plurality of pixel columns. Each pixel column receives an optical signal and converts the same to an electric signal. Each pixel column is composed of a plurality of optoelectric transducer elements, each of which is a “pixel.” Note that the ends (hatched in FIG. 1) of each pixel column are shielded from light.

The accumulation gate unit 102 comprises a plurality of accumulation gates that are associated with the pixels of the light receiving unit 101, respectively. Each accumulation gate transfers the electric signal (signal charge) generated by the associated pixel to the storage unit 103. The storage unit 103 comprises a plurality of storage elements that are associated with the accumulation gates of the accumulation gate unit 102. Each storage element holds the signal charge transferred from the associated accumulation gate. The transfer gate unit 104 comprises a plurality of transfer gates that are associated with the storage elements, respectively. Each transfer gate transfers a signal charge from the associated storage element to the CCD transfer path 105.

As FIG. 1 shows, the four-piece units, each composed of a pixel, accumulation gate, storage element and transfer gate, are arranged along the CCD transfer path 105. The signal charge generated in each pixel is transferred in the CCD transfer path 105, passing through the accumulation gate, storage element and transfer gate.

The floating diffusion amplifier (FDA) 106 is connected to the output of the CCD transfer path 105. The FDA 106 converts each signal charge transferred from the CCD transfer path 105, to an analog voltage signal (pixel signal) Vfda according to the charge. The pixel signal Vfda is output to the reading circuit, which will be described later.

The monitor pixel unit 107 comprises a plurality of monitor pixels that are arranged parallel to the pixel columns of the light receiving unit 101, respectively. The monitor pixels are connected to the accumulation-end determining circuit 111. Each monitor pixel receives an optical signal almost equivalent to the optical signal supplied to the associated pixel column of the light receiving unit 101, and converts the optical signal to a voltage signal. The voltage signal is output to the accumulation-end determining circuit 111. On receiving the voltage signal, the accumulation-end determining circuit 111 determines that the associated pixel column has accumulated the signal charge.

How the CCD image sensor unit 100 operates will be explained with reference to the timing chart of FIG. 2. At the top In FIG. 2, operation mode, accumulating mode and pixel reading mode, are shown, in which the CCD image sensor unit 100 may operate. FIG. 2 also shows various signals, downwards one after another. They are: clock CLK coming from the control circuit 200, control signals phi_1 and phi_2 supplied to the CCD transfer path 105, control signal phir supplied to the FDA 106, control signals phitg1_1, phitg1_2 and phitg1_n supplied to the accumulation gate unit 102, control signal phitg2 supplied to the transfer gate unit 104, control signal phi_rs supplied to the storage unit 103, control signal phi_rm supplied to the monitor pixel unit 107, control signals detect_1, detect_2 and detect_n coming from the accumulation-end determining circuit 111, voltage signals Vmpd_1, Vmpd_2 and Vmpd_n coming from the monitor pixels, and voltage signal Vfda output from the FDA 106.

The control signals phitg1_1, detect_1 and voltage signal Vmpd_1 are concerned with the first pixel column (e.g., the leftmost pixel column shown in FIG. 1). The control signals phitg1_2, detect_2 and voltage signal Vmpd_2 are concerned with the second pixel column. The control signals phitg2_n, detect_n and voltage signal Vmpd_n are concerned with the nth pixel column. Hereinafter, the control signals phitg1_1, phitg1_2 and phitg1_n will be represented by control signal phitg1, the control signals detect_1, detect_2 and detect_n by control signal detect, and voltage signals Vmpd_1, Vmpd_2 and Vmpd_n by voltage signal Vmpd, for simplicity of explanation.

The conditions under which the CCD image sensor unit 100 accumulates electric charge and reads pixel signals are set in the setting mode. Then, the operating mode of the unit 100 is changed to the accumulating mode. Before the charge accumulating is started, the control signals phitg1 and detect remain at level “L”, while the control signals phi_rs and phi_rm remain at level “H”.

In the accumulating mode, the control signal phitg1 rises to level “H”. At this point, the signal charge accumulated in each pixel of the light receiving unit 101 flows to one storage element of the storage unit 103 through one accumulation gate of the accumulation gate unit 102. Thus, charges no longer remain in the pixels of the light receiving unit 101. When the control signal phi_rs rises to level “H”, the charge flows from each storage element of the storage unit 103. While the control signal phi_rm remains at level “H”, the charge flows from each monitor pixel of the monitor pixel unit 107. Now that as the light receiving unit 101, storage unit 103 and monitor pixel unit 107 accumulate no electric charges, they can accumulate new charges.

When the control signal phitg1 and phi_rm fall to level “L”, the light receiving unit 101 and monitor pixel unit 107 start accumulating signal charges. While the light receiving unit 101 and monitor pixel unit 107 are accumulating the signal charges, the control signal phi_rs falls to level “L”. At this point, the storage unit 103 is holding electric charges. Each pixel of the light receiving unit 101 and each monitor pixel of the monitor pixel unit 107 therefore accumulate charges corresponding to the light beams applied to them. Each monitor pixel of the monitor pixel unit 107 outputs a voltage signal Vmpd. This signal Vmpd corresponds to the charge accumulated in the monitor pixel.

When the voltage signal Vmpd output from any monitor pixel falls below the accumulation-end voltage Vref set in the accumulation-end determining circuit 111, the accumulation-end determining circuit 111 sets, to level “H”, the control signal detect corresponding to the voltage signal Vmpd (charge in the monitor pixel). When the control signal detect rises to level “H”, the control circuit 200 sets, to level “H”, the control signal phitg1 supplied to the pixel column associated with the control signal detect. The control signal phitg1 is held at level “H” for a prescribed period. As a result, the electric charges flow from the light receiving unit 101 to the storage unit 103 through the accumulation gate unit 102. The pixel column therefore assumes an accumulation-end state. Such an accumulation control is performed on any other pixel column. Until all pixel columns assume the accumulation-end state, the storage unit 103 keeps holding the electric charges.

When all pixel columns come to assume the accumulation-end state, the operating mode of the CCD image sensor unit 100 is changed from the accumulating mode to the pixel reading mode. In the pixel reading mode, the control signal phitg2 remains at level “H” for the prescribed period. For this period, the electric charges are transferred from the storage unit 103 through the transfer gate unit 104 to the CCD transfer path 105. Thus, the pixel signals are read.

How the CCD image sensor unit 100 operates in the pixel reading mode will be explained in detail, with reference to FIG. 3. In the timing chart of FIG. 3, signals CLK, phitg2, phi1, phi2, phir and Vfda are shown from the top, in the order mentioned.

As described with reference to FIG. 2, the electric charges generated in the light receiving unit 101 are stored in the storage unit 103 in the accumulation-end state. In this state, the control signal phitg2 may rise to level “H”. Then, the electric charges are supplied from the storage unit 103 via the transfer gate unit 104 to the CCD transfer path 105. In the CCD transfer path 105, the electric charges are sequentially transferred in accordance with the control signals phi1 and phi2. Controlled by the control signal phir, the FDA 106 converts each signal charge transferred from the CCD transfer path 105, into a voltage signal Vfda for each pixel or group of pixels. The voltage signal Vfda is output to the reading circuit, which will be described later. The reading circuit processes the voltage signal Vfda generated by the FDA 106 for each pixel or group of pixels, in accordance with the control signal phir that is synchronous with the control clock CLK.

Thus, the transfer of signal charges, accomplished by using the control signals phi1 and phi2, and the resetting of the FDA 106, achieved by using the control signal phir, generate a voltage signal Vfda. Hence, the voltage Vfda is output in three periods. Hereinafter, the three periods shall be referred to as reset period t_{R}, zero-level period t₀, and signal period t_{S}, respectively. In the reset period, the control signal phir remains at level “H”, and the signal charge in the FDA 106 is changed back to a specific value through charging and discharging. Therefore, the output signal Vfda of the FDA 106 stays at reset voltage Vr(x), i.e., a fixed level, in the reset period t_{R}.

Next, when the control signal phir falls from level “H” to level “L”, the output signal Vfda of the FDA 106 changes to a different voltage from the reset voltage Vr(x), due to the feed-through in the FDA 106. In the zero-level period to, the control signal phir remains at level “L”, having fallen from level “H”, until the control signals phi1 and phi2 change. The voltage at which the voltage signal Vfda output from the FDA 106 remains in this period shall be referred to as feed-through voltage Vf(x).

The third period, i.e., signal period t_{S} starts at the end of the zero-level period t₀ and ends at the time the control signal phir rises again to level “H”. The voltage at which the voltage signal Vfda remains during this period t_{S}, shall be referred to as signal voltage Vs(x). This signal voltage Vs(x) changes in accordance with the electric charge transferred from the CCD transfer path 105. As shown in FIG. 2, the control signal phir rises to level “H” every time the control signals phi1 and phi2 change. The signal voltage Vs(x) is thereby changed for every pixel.

As pointed out above, the CCD image sensor unit 100 outputs signals having periodicity, in synchronization with the control clock CLK.

Note that suffix “x” to voltages Vr(x), Vf(x) and Vs(x), i.e., the voltages the output signal Vfda of the FDA 106 may have, indicate the pixel number. In FIG. 3, x=0 to 7. The smaller “x” is, the closer the pixel lies to the FDA 106.

The reading circuit, which is an example of the signal processing apparatus according to this embodiment, will be described with reference to FIG. 4. As FIG. 4 shows, the reading circuit has an analog signal output circuit 300 and an operation circuit 400.

The analog signal output circuit 300 has a correlated double-sampling (CDS) circuit 301, a first sample-and-hold (SH) circuit 302, and a second SH circuit 303.

The CDS circuit 301 is connected to the output of the FDA 106 incorporated in the CCD image sensor unit 100. Controlled by a control signal coming from the control circuit 200, the CDS circuit 301 generates a signal Vcds(x) by operationally amplifying the difference between the signal voltage Vs(x) and feed-through voltage Vf(x) of the voltage signal Vfda. The first SH circuit 302 and second SH circuit 303 sample and hold the output Vcds of the CDS circuit 301, under the control of a control signal coming from the control circuit 200.

The operation circuit 400 is constituted by a clamp circuit 401. The clamp circuit 401 has the configuration shown in FIG. 5. As FIG. 5 shows, the clamp circuit 401 comprises an operational amplifier OP, an input capacitance Ci, a feedback capacitance Cf, connection-changeover switches S1 and S2, a feedback switch S3, and a reference voltage source Vref. The input capacitance Ci is connected, at one end, to the inverting input terminal of the operational amplifier OP and, at the other end, to one end of the connection-changeover switch S1 and S2. The other end of the connection-changeover switch S1 is connected to the output of the operational amplifier OP. The other end of the connection-changeover switch S2 is connected to the output of the reference voltage source Vref. The feedback switch S3 is provided between, and connected to, the inverting input and output terminals of the operational amplifier OP. The non-inverting input terminal of the operational amplifier OP is connected to an input terminal Vsc2 provided to receive the voltage signal Vsc2 from the second SH circuit 303. The output terminal of the operation amplifier OP serves as a terminal for outputting the voltage signal Vout generated by the operation circuit 400. The connection-changeover switches S1 and S2 and the feedback switch S3 are opened or closed by a clamp signal clp externally input.

The clamp circuit 401 of in FIG. 5 performs clamping when the clamp signal clp rises to level “H”, the connection-changeover switch S1 is opened, and the connection-changeover switch S2 and feedback switch S3 are closed.

In FIG. 4, the CCD image sensor unit 100 and the control signals for controlling the unit 100 are illustrated in simplified form. Control signal phi shown in FIG. 4 represents the control signals phi1, phi2, pitg1_1, phitg1_2, phitg1_n, phitg2, phi_rs and phi_rm. Control signal detect represents control signals detect_1, detect_2 and detect_n.

How the analog signal output circuit 300 operates will be explained with reference to the timing chart of FIG. 6. In FIG. 6, the control clock CLK supplied from the control circuit 200, the output Vfda of the FDA 106, the control signal shcds supplied to the CDS circuit 301, the output Vcds of the CDS circuit 310, the control signal shsc1 supplied to the first SH circuit 302, the control signal shsc2 supplied to the second SH circuit 303, the output Vsc1 of the first SH circuit 302, the output Vsc2 of the second SH circuit 303, are shown from the top, in the order they are mentioned.

The control signal shcds rises to level “H” in the zero-level period t₀ of the voltage signal Vfda. While the control signal shcds remains at level “H”, the CDS circuit 301 holds the feed-through voltage Vf(x) of the voltage signal Vfda. While the control signal shcds remains at level “L”, the CDS circuit 301 operationally amplifies the difference between the feed-through voltage Vf(x) and the signal voltage Vs(x), generating a voltage signal Vcds(x). The period in which this voltage signal Vcds(x) is output shall be called CDS operation period t_{CDS}. In FIG. 6, the waveforms are illustrated on the assumption that the CDS circuit 301 operates as an inverting amplifier circuit having an amplification factor of Av1. The operating characteristic of the CDS circuit 301 is given as follows:

Vcds(x)=−Av1×(Vf(x))−Vs(x)) (1)

The first SH circuit 302 and the second SH circuit 303 are sample-and-hold circuits that stay in a sampling state while the control signals shsc1 and shsc2 remain at level “H”, and in a holding state while the control signals shsc1 and shsc2 remain at level “L”. The control signals shsc1 and shsc2 remain at level “H” in the CDS operation period t_{CDS}. The first SH circuit 302 and the second SH circuit 303 therefore sample the voltage signal Vcds(x). The first SH circuit 302 and the second SH circuit 303 keep holding the voltage signal Vcds(x) until the control signals shsc1 and shsc2 rise to level “H” again. Eventually, the first SH circuit 302 outputs a voltage signal Vsc1(x) for one pixel, and the second SH circuit 303 outputs a voltage signal Vsc2(y) used as a reference signal. Hereinafter, the period in which the first SH circuit 302 holds the voltage shall be called first hold period t_{SH1}, and the period in which the second SH circuit 303 holds the voltage shall be called second hold period t_{SH2}.

How the operation circuit 400 operates will be explained with reference to the timing chart of FIG. 7. In FIG. 7, clock CLK, output Vsc1, output Vsc2, control signal clp for the clamp circuit 401, and output signal Vout of the clamp circuit 401 are shown from the top, in the order mentioned.

While the control signal clp stays at level “H”, the clamp circuit 401 remains in a clamping state, holding the reference voltage Vsc2(y) and the reference voltage Vref. While the control signal clp stays at level “L”, the clamp circuit 401 remains in a signal-outputting state. In the signal-outputting state, the clamp circuit 401 amplifies the difference between the voltage signals Vsc1 and Vsc2 output from the first circuit 302 and the second SH circuit 303, respectively, with respect to the reference voltage Vref, by using the amplification factor of Av2, thereby generating a voltage signal Vout(x). The operating characteristic of the clamp circuit 402 is given as follows:

Vout(x)=−Av2×(Vsc2(y)−Vsc1(x))+Vref (2)

The voltage signal Vout(x) is valid as an output for a period identical to the first hold period t_{SH1}. The period for which the signal Vout(x) shall be hereinafter called one-pixel reading period t_{SIG}.

As indicated above, the reading circuit for reading signals from the CCD image sensor unit 100 outputs a signal having periodicity in synchronization with the control clock CLK. Suffix “x” to Vr(x), Vf(x), Vs(x), Vcds(x), Vsc1(x) and Vout(x) indicates the pixel number. In FIGS. 6 and 7, x=0 to 7. Suffix “y” to Vsc2(y) indicates a pixel number different from the pixel number indicated by suffix “x”. More precisely, “y” indicates the number of any shielded pixel in FIG. 1. In FIGS. 6 and 7, y=0.

The pixels constituting the light receiving unit 101 will be described in detail, with reference to FIG. 8. As has been described, the light receiving unit 101 is comprised of a plurality of pixel columns (e.g., pixel columns 1, 2, 3, . . . shown in FIG. 8), and each pixel column is composed of a plurality of pixels.

The pixels of each pixel column are arranged in a line, some being open pixels and others being shielded pixels. Each open pixel accumulates an electric charge corresponding to the amount of light it has received. Each shielded pixel is an optoelectric transducer element that receives no light at all. When the shielded pixels output voltage signals, the clamp circuit 401 performs clamping. The clamp circuit 401 amplifies the difference between the output of a shielded pixel (equivalent to Vsc2(y)) and the output of another pixel (equivalent to Vsc1(x)), with respect to the reference voltage Vref, generating a signal. This signal is output, as output signal Vout(x) of the operation circuit 400.

The clamping that the clamp circuit 401 performs will be further explained, with reference to the timing chart of FIG. 9. In FIG. 9, signals phi1, clp and Vout are shown from the top, in the order mentioned.

The operation circuit 400 assumes a signal-outputting state while the control signal clp remains at level “L”. More precisely, the clamp circuit 401 outputs a signal Vout(x) that changes in synchronization with the control signal phi1. While the control signal clp remains at level “H”, the operation circuit 400 assumes a clamping state. In the clamping state, the clamp circuit 401 outputs a signal at the same level as the signal Vsc2(y) supplied to the non-inverting input terminal of the operational amplifier OP.

At the time the control signal clp rises from level “L” to level “H”, a ringing develops in the output voltage signal Vout of the operation circuit 400. The ringing develops because the clamp circuit 401 changes in configuration from a switched-capacitor inverting amplifier to a voltage-follower circuit at the time the clamp signal clp rises from level “L” level to level “H”. If the frequency of the transfer clock (i.e., control signal phi1) is increased and if the clamping may be performed in the conventional method, the transition period t_{TRN} in which the ringing developing when the control signal clp rises from level “L” to level “H” ceases may be longer than the clamp period t_{CLP}. In this case, an erroneous clamping may be performed in the operation circuit 400.

Hence, if the one-pixel reading period t_{SIG} is shorter than the transition period t_{TRN}, it is desirable to render the clamp period t_{CLP} longer than the one-pixel reading period t_{SIG}, (t_{CLP}>t_{SIG}). If the clamp period t_{CLP} is longer than the one-pixel reading period t_{SIG}, it will be longer than the transition period t_{TRN}, and the clamping can be completed within a stable period t_{STB}.

Thus, if the clamp period t_{CLP} and the one-pixel reading period t_{SIG} are set independently, not set to the same value, the voltage held in the operation circuit 400 will not fluctuate in spite of the ringing even if the transfer clock has a high frequency. The clamping is performed only once while the voltage signal Vout is being output, or only once for every pixel column. Therefore, the clamp period t_{CLP} will influence the reading time only a little.

A specific means for lengthening the clamp period t_{CLP} in the present embodiment will be explained. FIGS. 10 to 12 are timing charts showing the waveforms of the control signals used in the operation circuit 400 and the waveforms of the input and output signals of the operation circuit 400. In FIGS. 10 to 12, CLK, phi1, clp, Vsc1, Vsc2 and Vout are shown from the top, in the order mentioned.

In the case illustrated in FIG. 10, the frequency-division ratio of the control signal phi1 is supplied from the control circuit 200 to control the control clock CLK only while the clamping control signal clp remains at level “H”. In the case illustrated in FIG. 10, the frequency dividing ratio of the control signal phi1 is high only while the clamping control signal clp remains at level “H”, so that the control signal phi1 may delayed falls to level “L”. The clamp period t_{CLP} can thereby be made longer than the one-pixel reading period t_{SIG}.

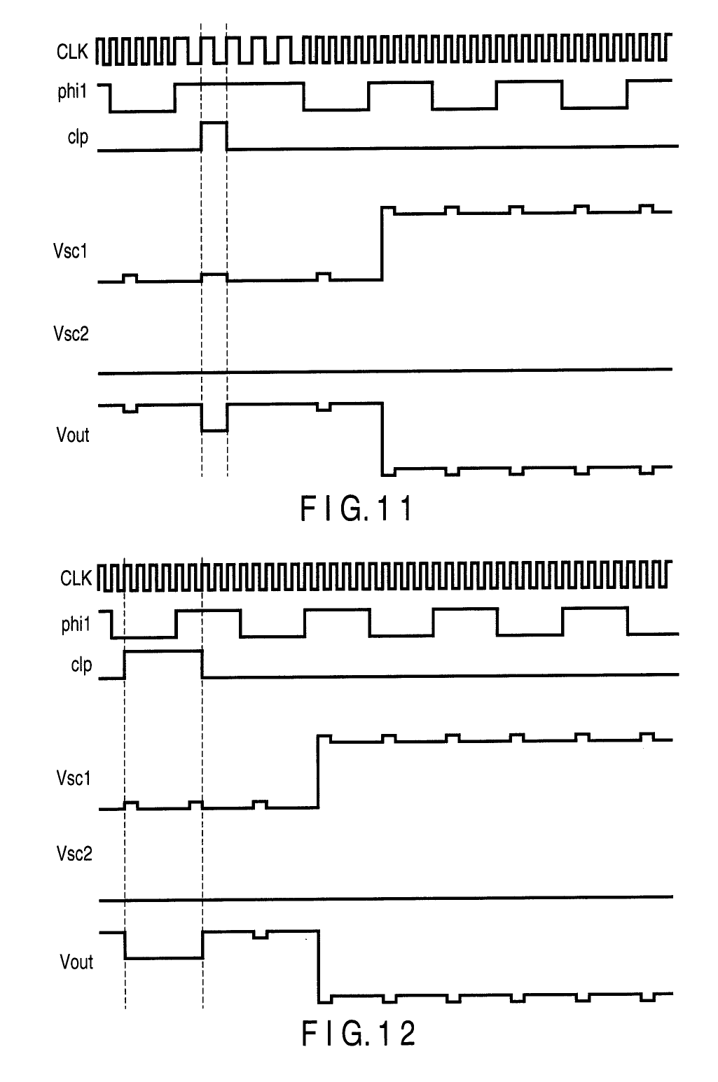

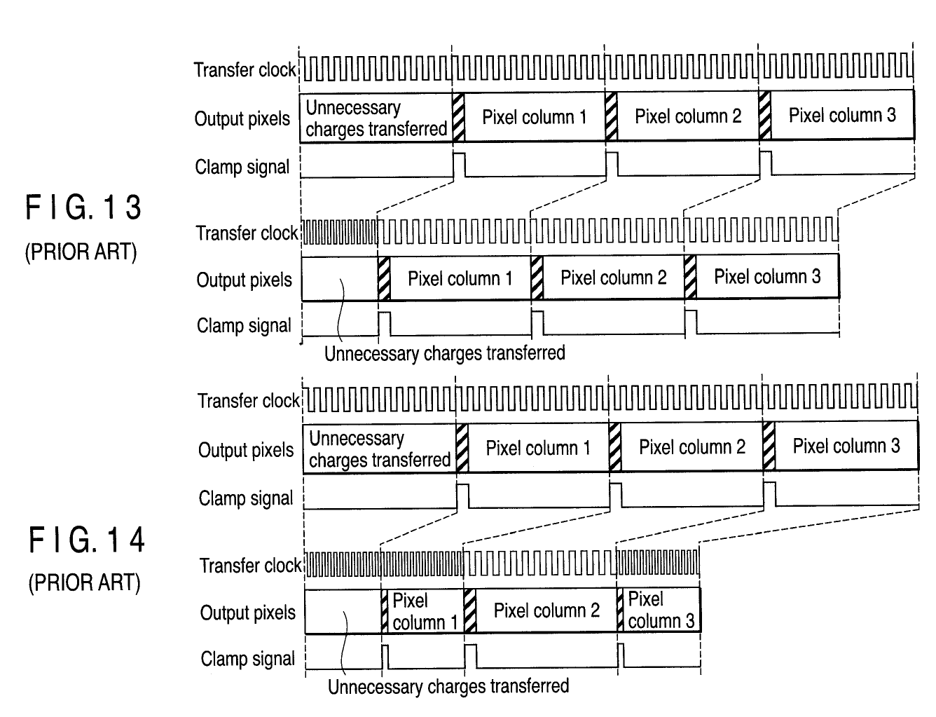

In the case illustrated in FIG. 11, the frequency of the control clock CLK is decreased only while the control signal clip remains at level “H” to perform clamping. In this method, too, the control signal phi1 delayed falls to level “L”, lengthening the clamp period t_{CLP}.

In the case shown in FIG. 12, the control signal clp is raised to level “H” for the pixel preceding the target pixel that should hold a voltage to perform clamping, thereby completing the clamping at the target pixel. This method is equivalent to one that uses two or more pixels as clamp pixels in such a pixel configuration as shown in, for example, FIG. 8. By this method, too, the clamp period t_{CLP} can be lengthened.

As has been described, the present embodiment can shorten the time for reading analog signals regardless of the ringing that develops during the clamping.

Moreover, the clamping is performed on each pixel column, independently of any other pixel column that differs in terms of charge-storing time. This eliminates the pixel-signal reading error at any pixel column.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A signal processing apparatus comprising:
an analog signal outputting circuit configured to output an analog signal divided into blocks in synchronization with a clock;
an operation circuit configured to operate in a clamping state to hold a reference signal and in a signal outputting state to output an effective signal by performing a specific operation on the analog signal with respect to the reference signal; and
a control circuit configured to control the operation circuit, causing the operation circuit to operate in the clamping state longer than a period in which one block of the analog signal is output while the operation circuit remains in the signal outputting state.

2. The signal processing apparatus according to claim 1, wherein the analog signal outputting circuit comprises:
a light receiving unit having a plurality of light receiving elements configured to accumulate electric charges generated through optoelectric conversion;
a plurality of storage units, each configured to store the electric charges supplied from the light receiving elements of the light receiving unit; and
a transfer unit configured to transfer the electric charges from each of the storage units, and
the light receiving elements constitute pixel columns, the time for which the electric charges are accumulated in each pixel column is controlled, and the operation circuit operates in the clamping state while any pixel column accumulates the electric charges.

3. The signal processing apparatus according to claim 1, wherein the operation circuit comprises:
an operational amplifier;
a first capacitance connected at one end to an inverting input terminal of the operational amplifier and at the other end to the analog signal outputting circuit;
a second capacitance connected at one end to the inverting input terminal of the operational amplifier;
a first switch connected at one end to the second capacitance and at the other end to an output terminal of the operational amplifier or an input terminal for the reference signal;
a second switch provided between, and connected to, the inverting input and output terminal of the operation amplifier; and
a reference signal source connected to a non-inverting input terminal of the operational amplifier, and
the control circuit renders a period in which the second switch remains closed longer than the duration of any block of the analog signal output from the analog signal outputting circuit.

4. The signal processing apparatus according to claim 1, wherein the control circuit makes a period in which the operation circuit remains in the clamping state longer than the duration of any block of the analog signal, by changing the frequency dividing ratio of the clock in synchronization with changes in a state of the operation circuit.

5. The signal processing apparatus according to claim 4, wherein the control circuit increase a frequency dividing ratio applied to the clock while the operation circuit remains in the clamping state, over a frequency dividing ratio applied to the clock while the operation circuit remains in the signal outputting state.

6. The signal processing apparatus according to claim 1, wherein the frequency of the clock supplied to the control circuit is changed in synchronization with changes in a state of the operation circuit, thereby making a period in which the operation circuit remains in the clamping state longer than the duration of any block of the analog signal.

7. The signal processing apparatus according to claim 6, wherein the frequency the clock has while the operation circuit remains in the clamping state is lower than the frequency the clock has while the operation circuit remains in the signal outputting state.

8. The signal processing apparatus according to claim 1, wherein the analog signal is divided into blocks in synchronization with the clock and contains an effective analog signal on which the specific operation is performed while the operation circuit remains in the signal outputting state; the period in which the operation circuit remains in the clamping state corresponds to a period in which the signal outputting circuit outputs an analog signal other than the effective analog signal; and the control circuit makes a period in which the operation circuit remains in the clamping state longer than a duration of any block of the analog signal.
